(19) United States
(12) Patent Application Publication
(10) Pub. No.: US 2016/0140301 A1
(43) Pub. Date: May 19, 2016

(54) VALIDATION OF DIGITAL SURGICAL VIDEOS

(71) Applicant: GDT INNOVATIONS, LLC, Little Rock, AR (US)

(72) Inventors: Gresham T. Richter, Little Rock, AR (US); Deepak Mehta, Little Rock, AR (US)

(21) Appl. No.: 14/932,415

(22) Filed: Nov. 4, 2015

Related U.S. Application Data
(60) Provisional application No. 62/079,334, filed on Nov. 13, 2014.

(51) Int. Cl. G06F 19/00; G06Q 30/00; G06Q 30/02

(52) U.S. Cl. CPC G06F 19/327; G06F 19/324; G06Q 30/0282; G06Q 30/018

(57) ABSTRACT

Computer-implemented methods and systems for validating digital surgical videos are disclosed herein. According to an embodiment, an Internet-based method for validating a digital video comprises submitting the digital surgical video to a video hosting website; analyzing and accepting the video for a pre-publication review, wherein the pre-publication review comprises automatically assigning the accepted video to at least two randomly selected reviewers using a computer algorithm; automatically associating an approved for publication status identifier with the video; and embedding an indicia representative of validation of the video content in the approved for publication video.

### CROSS REFERENCE TO RELATED APPLICATIONS

This application claims the benefit of U.S. Provisional Application No. 62/079,334, filed Nov. 13, 2014, the content of which is incorporated by reference in its entirety.

### BACKGROUND OF THE INVENTION

The present invention generally relates to validating digital files and, more particularly, to Internet-based methods and systems for the validation of digital videos.

In recent years, learning content has gradually migrated to the Internet. Online digital videos are a convenient instruction tool. Digital instructional videos have diverse content. Internet-based searching services or “search engines” allow users to search for specific content. Currently, there are numerous websites that provide medical and surgical information along with related digital videos. However, there is no mechanism available for patients to determine if the content of these videos is accurate or valid.

### BRIEF SUMMARY OF THE INVENTION

The Internet allows easy and convenient access to information. Information on diseases, medical conditions and surgical and treatment procedures, that could only be found in specialized print journals in the past, is now available online. Many websites provide digital videos on select medical and surgical procedures. However, because of the all prevalent nature of the Internet, a simple query can result in an unmanageable number of search results. It becomes very difficult for a layperson to sift through this information to determine which websites provide reliable and valid content. Available medical videos may be too long, sporadic and difficult for a patient or family member to understand. Some of the available videos are of poor or amateurish quality. Accordingly, these videos may create a faulty perception of the surgical procedure. Also, it is sometimes difficult to find digital videos on certain uncommon medical procedures.

Exemplary embodiments discussed herein provide an Internet-based technical solution to provide validated medical and digital videos prior to publication online. The validation process can ensure that the content and presentation of each published video meets predetermined criteria. Furthermore, the published digital videos can cover a wide range of medical and surgical procedures and the videos can be conveniently accessed and understood even by non-medical personnel. The proposed Internet-based technical solution can also ensure that the digital videos are not subjected to unauthorized copying.

In one embodiment, the present disclosure describes Internet-based methods and computer systems for validating digital files, including digital media files. In one embodiment, an Internet-based method for validating a digital video comprises submitting the digital video to a dedicated surgical video hosting website. The video can include content on a surgical procedure. Submitting the video involves: using a drag and drop movement, copying the video from a client device to a designated region on a webpage of the video hosting website; using a computer system, analyzing and accepting the video for a pre-publication review, wherein the video is accepted for the pre-publication review upon ensuring that the video content is in compliance with a set of predetermined criteria, and wherein the pre-publication review comprises: using a computer algorithm, automatically assigning the accepted video to at least two randomly selected reviewers; upon receipt of approval from each of the randomly selected reviewers, using the computer system, automatically associating an approved for publication status identifier with the video; and embedding pre-determined digital data in the video having the approved for publication status identifier, wherein the digital data comprises an indicia representative of validation of the video content.

The method further comprises submitting predetermined information associated with the video, wherein the predetermined information comprises one or more metatags or keywords, an overview of the surgical procedure and an abstract of the surgical procedure. The method involves, using the computer system, analyzing the one or more metatags or keywords prior to assigning the video to each of the reviewers. Each of the selected reviewers can be experienced in the surgical procedure. The method further involves comprising automatically storing, in a non-transitory computer readable storage medium, information pertaining to a plurality of designated reviewers, wherein each of the designated reviewers is experienced in at least one surgical procedure.

In one embodiment, the validation indicia comprises a data item or an information element, wherein the information element comprises a logo, a predetermined word, phrase, number or combinations thereof. In another embodiment, the validation indicia can include a digital watermark, wherein the digital watermark comprises a second level domain portion of an URL associated with the video hosting website, the URL associated with the video hosting website and combinations thereof. The digitally watermarked video can be published on the video hosting website. The method may involve converting the video into a predetermined format prior to publishing. The method includes automatically categorizing the published video based on the surgical procedure. The method can further involve associating a digital image with the categorized published video.

In another embodiment, an Internet-based method for validating a digital video includes: using a computer system, evaluating and analyzing content of a surgical video embedded in a third party website; accessing the video on the third party website from a dedicated video hosting website, wherein the video is accessed upon the condition that the content of the evaluated video satisfies predetermined guidelines; using the computer system, associating a non-validated status identifier with the accessed video, wherein the associated status identifier is displayed on a webpage of the video hosting site; automatically permitting registered members of the video hosting website to assign a score to the accessed video based on a plurality of evaluation criteria; and using the computer system, automatically modifying the status identifier to a validated status upon detecting that the video has been assigned a score that meets or exceed a predetermined threshold score.

### BRIEF DESCRIPTION OF THE DRAWINGS

The accompanying drawings illustrate various implementations and are a part of the specification. The illustrated implementations are merely examples and do not limit the scope of the disclosure. Throughout the drawings, identical reference numbers designate identical or similar elements.

FIG. 1 illustrates a block diagram of the overall architecture according to an embodiment of the invention.

FIG. 2 is a flowchart illustrating a method for accepting videos for validation according to an embodiment of the invention.

FIG. 3 is a flowchart illustrating a method for validation of videos according to an embodiment of the invention.

FIG. 4 is a flowchart illustrating a method for accepting videos for display according to another embodiment of the invention.

FIG. 5 is an exemplary webpage of the video hosting site according to another embodiment of the invention.

### DETAILED DESCRIPTION

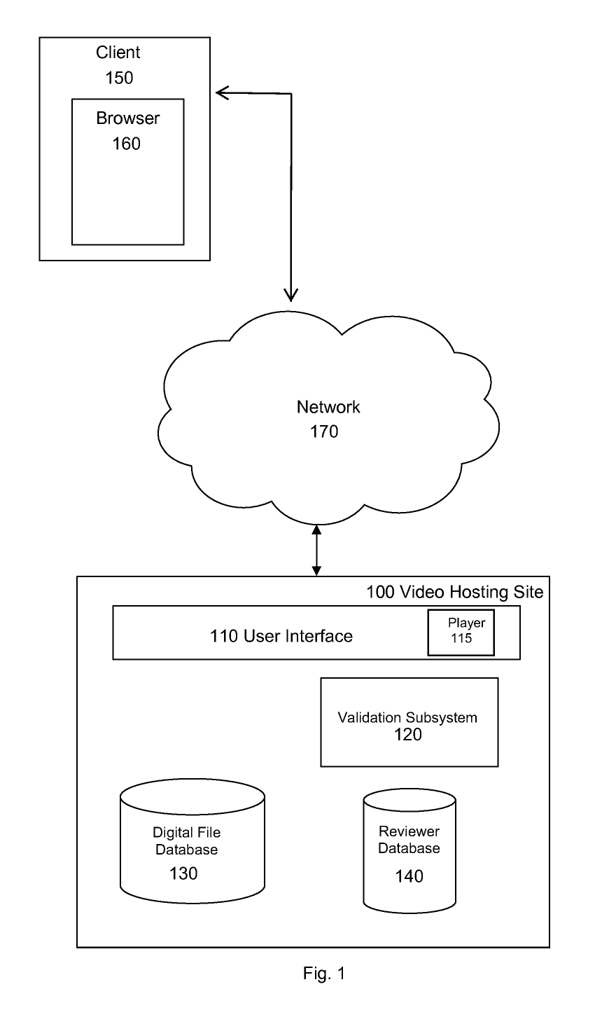

FIG. 1 is an exemplary block diagram of an overall architecture according to an embodiment of the invention. As shown in FIG. 1, a video hosting website (or “site”) 100 communicates with a client 150 through a user interface 110. Elements of the video hosting site 100 may communicate with one another and the client 150 using any suitable communication technologies, devices, media, and protocols supportive of data communications, including, but not limited to, the Internet, intranets, local area networks, other communications networks, data transmission media, communications devices, Transmission Control Protocol (“TCP”), Internet Protocol (“IP”), File Transfer Protocol (“FTP”), Telnet, Hypertext Transfer Protocol (“HTTP”), socket connections, Ethernet, data bus technologies, and other suitable communications technologies. As shown, the video hosting site 100 communicates with the client 150 via network 170. The network 170 may be the Internet or any network, including but not limited to a LAN, a WAN, a mobile, wired or wireless network, a private network, or a virtual private network, or any combination thereof.

The video hosting site 100 is a dedicated website for storing and displaying videos exclusively on medical and surgical procedures. The video hosting site 100 may also be a web portal comprising a website or another suitable online forum. An example of a surgical video hosting site 100 is the CSurgeries™ website, found at www.csurgeries.com. While an exemplary video hosting site 100 is shown in FIG. 1, the exemplary components illustrated in the Figure are not intended to be limiting. Other alternative hardware environments and implementations may be used in other implementations. For instance, only one client 150 is shown. However, a large number of clients that can be supported by the hardware and software implementations may be in communication with the video hosting site 100 at any time. The video hosting site 100 may include other conventional features such as, firewalls, authentication servers, application servers, and so forth which are not shown.

In certain implementations, one or more elements of video hosting site 100 may be implemented as single pieces of software or hardware or as multiple pieces of software or hardware. The video hosting site 100 may include any computer hardware and/or instructions (e.g., software programs), or combinations of software and hardware, configured to perform the processes described herein. In particular, it should be understood that elements of video hosting site 100 may be implemented on one or more physical computing devices. Accordingly, video hosting site 100 may include any one of a number of computing devices (e.g., one or more servers), and may employ any of a number of computer operating systems. The video hosting site 100 may also employ any of a number of database management tools, including, but not limited to, known versions and/or varieties of Microsoft SQL Server and DB2.

It is understood that functions described in one embodiment as being performed by one component, can also be performed by other components in other embodiments, or by a combination of components. One or more of the processes described herein may be implemented at least in part as instructions executable by one or more computing devices. In general, a processor (e.g., a microprocessor) receives instructions, e.g., from a memory, a computer-readable medium, etc., and executes those instructions, thereby performing one or more processes, including one or more of the processes described herein. Such instructions may be stored and transmitted using a variety of known computer-readable media.

A computer- or processor-readable medium may include any medium that participates in providing data (e.g., instructions) that may be read by a computer (e.g., by a processor of a computer). Such a medium may take many forms, including, but not limited to, non-volatile media, volatile media, and transmission media. Non-volatile media may include, for example, optical or magnetic disks and other persistent memory. Volatile media may include, for example, dynamic random access memory (“DRAM”), which typically constitutes a main memory. Transmission media may include, for example, coaxial cables, copper wire and fiber optics, including the wires that comprise a system bus coupled to a processor of a computer. Transmission media may include or convey acoustic waves, light waves, and electromagnetic emissions, such as those generated during radio frequency (“RF”) and infrared (“IR”) data communications. Common forms of computer-readable media may include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

The described servers can be implemented as server programs executing on server-class computers comprising a CPU, memory, network interface, peripheral interfaces, and other well-known components. Also, any other type of computer can be used, and it is expected that as more powerful computers are developed in the future, they can be configured in accordance with the teachings here. The functionality implemented by any of the elements can be provided from computer program products that are stored in computer-readable storage mediums (e.g., RAM, hard disk, or optical/magnetic media) or by equivalent implementations in hardware and/or firmware.

The video hosting site 100 can include a user interface 110, a validation subsystem 120, a video database 130 and a reviewer or subject matter expert database 140. User interface 110 may comprise one or more graphical user interfaces (“GUIs”) configured to display information and communicate with client 150. In certain exemplary implementations, user interface 110 includes a web browser, such as Internet Explorer, Mozilla Firefox, Safari and the like. However, user interface 110 is not limited to web-based and/or graphical implementations and may include many different types of user interfaces that enable users to utilize client 150 to communicate with video hosting site 100. In some implementations, for example, user interface 110 may include a voice interface capable of receiving voice input from and/or providing voice output to a user.

The player 115 may be a video player (e.g., Flash™ from Adobe Systems, Inc.), or any other player adapted for the video file formats used in the video hosting site 100. The player 115 may be supplied by the video hosting site 100 or by a third-party website 140.

The video database 130 can be used to store the content of digital videos. The digital video includes content on any surgical procedure. The term “surgical procedure”, as used in this document, encompasses both medical and surgical procedures. For example, the videos may include content on procedures in the field of otolaryngology, orthopedics, general surgery, obstetrics and gynecology, vascular surgery, urology, spine surgery, plastic surgery, ophthalmology, and other such disciplines. The videos can include content on a diagnostic procedure, special or unique techniques, or common surgical procedures, such as, a tonsillectomy, robotic surgery, surgical instrument and device usages, or an appendectomy. Thus, the video hosting site 100 serves as a single repository of online information on a wide variety of surgical procedures.

The video database 130 can also store associated digital files. Associated digital files may include identifiable information or files related to each of the digital videos. For example, the associated information may include digitized text, other digital media, multimedia presentations, static images, audio, and combinations thereof. The digitized text may include abstracts or brief summaries of the surgical, information on the creator(s) or author(s) of the video, copyright transfer agreements, and metadata or keywords associated with each of the digital videos. The metadata or keywords (used interchangeably in this document) may describe characteristics of the video file or its content. For example, metadata stored may include a video title, name of the author, co-authors, a word or a short phrase regarding the surgical procedure, affiliated universities or hospitals for each author, etc. that can be used for identifying and categorizing the videos. The metadata may also include author descriptive statistics including number of published peer-reviewed publications, number of advanced degrees, number of years in a specialization and any such information that would be useful in categorizing and sorting the digital files. The metadata information can be obtained with a web crawler program. For example, the keyword may include the terms “tonsillectomy,” “cardiovascular surgery,” “appendectomy,” and other similar terms. In one aspect, the keyword may denote a surgical specialization.

The reviewer database 140 includes data or information on designated subject matter experts. Subject matter experts or reviewers are individuals who have been chosen to evaluate or review the content of the videos for accuracy and validity. These reviewers may be invited by the administrator of the video hosting site 100 to review and analyze the submitted videos and associated information based on their expertise in a surgical discipline. Thus, the subject matter experts are pre-qualified to serve as reviewers. The subject matter experts may be peers of the author. The reviewers may reside in any country. The reviewer database 140 may include the name, specialty, contact information, geographical location and other pertinent information related to the reviewer. The video and reviewer databases 130, 140 may include any suitable technologies useful for storing, accessing, retrieving, copying, and otherwise managing the videos and other digital files.

The reviewer database 140 (or the video database 130) can also store information on authors and other external users who create membership accounts with the video hosting site 100. The external user may be patients and their families, caregivers, medical students or residents, trainees, medical practitioners and surgeons, nurses and paramedical staff, pharmaceutical companies, hospitals, medical device companies, and, in general, any person who may be interested in viewing the hosted videos. The video database 130 may include information on the name, email identification, occupation and surgical specialization of the membership account holder. The video database 130 may also include data records that are type identifiers indicative of various types of users of the video hosting site 100. For example, a type identifier may indicate whether a data record is an author, a reviewer or a user record. The video database 130 may also associate and store permissions settings for the data records. For example, only reviewers may be allowed to rate certain third party videos. Permission settings may be included in one or more user profiles maintained by the video hosting site 100.

The client 150 includes a browser 160. An author can use the client 150 to upload or transmit videos to the video hosting site 100 using a browser 160 such as Mozilla Firefox, Apple Safari, Microsoft Internet Explorer, etc. Alternately, an external user can access the client 150 to communicate with the video hosting system 100 and access a video on a desired surgical procedure directly from the video hosting site 100 by visiting the site 100 and browsing a catalog of videos, conducting searches on keywords, etc.

The client 150 may include any device physically or remotely accessible to one or more users and that allows a user to provide input to and receive output from the video hosting site 100. For example, client 150 may include, but is not limited to, one or more desktop computers, laptop computers, tablet computers, personal computers, personal data assistants, cellular telephones, satellite pagers, wireless internet devices, embedded computers, video phones, mainframe computers, mini-computers, programmable logic devices, vehicular computers, Internet-enabled devices, and any other devices capable of communicating with video hosting site 100. Client 150 can also include or interact with various peripherals such as a terminal, keyboard, mouse, screen, printer, stylus, input device, output device, or any other apparatus that can help a user interact with the video hosting site 100.

A validation module 120 may be stored in memory. The validation module 120 includes computer program instructions for facilitating acceptance and validation of the content of submitted videos and associated information. The validation module 120 may also include computer program instructions for ensuring that the content of non-validated videos from third party websites may be re-categorized as validated if these videos meet or exceed a predetermined minimum threshold rating or evaluation score. The validation module 120 may be implemented as one or more sub-modules operating in separate software layers or in the same layer. The validation module 120 or one or more of the sub-modules may be incorporated as part of an operating system (not shown). In particular, one or more of the sub-modules may be incorporated as part of an interrupt handler. In some embodiments, the validation module 120 may be implemented in the software stack, in hardware, in firmware (such as in the BIOS), or in any other manner as will occur to those of ordinary skill in the art.

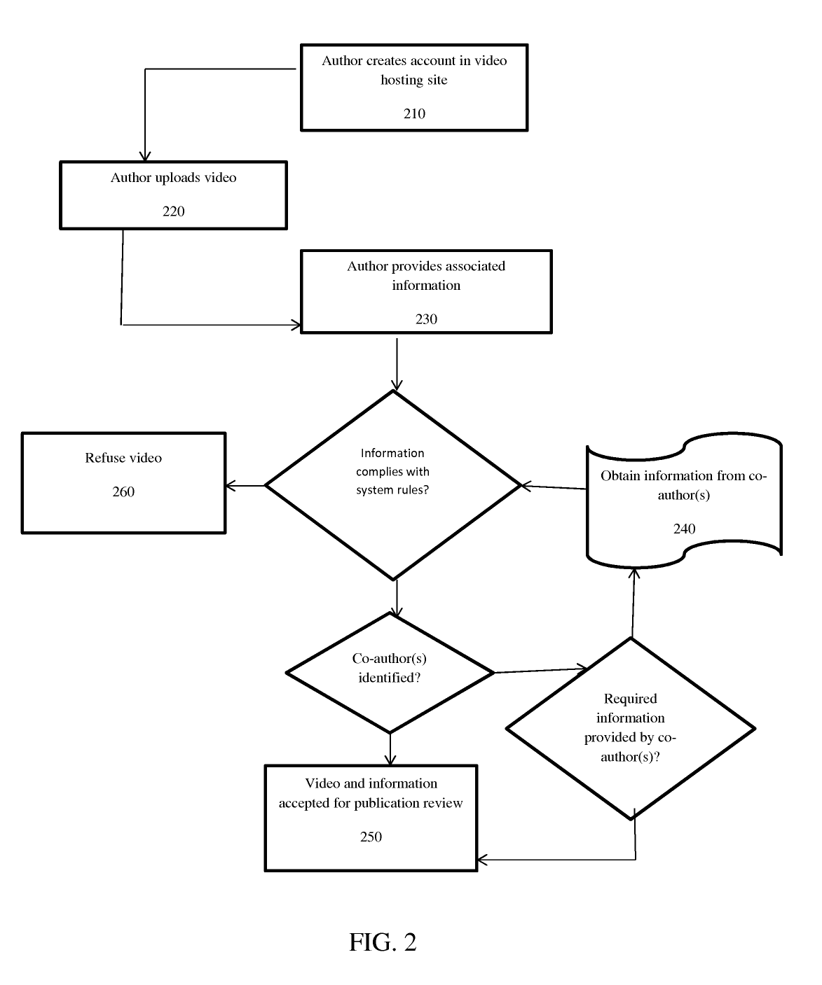

FIG. 2 illustrates a flowchart for accepting a video that is submitted to the video hosting site for publication review. The method involves requiring an author to create a member account on the video hosting site prior to submitting the video for publication review 210. The author is required to complete an online form to create a membership account. The form requires the author to create an account by entering his (or her) name and email address, selecting a password, identifying whether the author is a medical practitioner, and his area of specialization. After the author creates a member account, an automated email notification may be sent to his email address in order for the author to activate his membership. Membership can be activated by clicking on a hyperlink in the automated email notification or by copying a Uniform Resource Locator (URL) link into a browser of a client device.

The author can then login to the video hosting site using his membership account credentials (such as, email address and password). The author may be required to click on a “Submit Videos” button (or a similar feature) to be directed to a webpage or screen where he can upload the video 220. The video can be uploaded by a drag and drop movement from a hard drive of a client device or another computer readable storage medium. The video may be dragged and dropped to a designated region on the screen.

According to an aspect, the content of the submitted video may be created and narrated by or created under the supervision of a surgeon, a physician or other medical practitioner or a team of surgeons, physicians and medical practitioners. Each surgeon/physician/medical practitioner who is involved, either directly or indirectly, with the creation of the video is designated as an author of the video. Where multiple authors are involved in the creation of the video content, typically only one of the authors is required to create a membership account.

Various studies have shown that videos with short and concise content are optimal for tutorial purposes and for sustaining viewer interest. Accordingly, a requirement for the submitted video is that it should be a short video. According to an aspect, the video may be about 1-6 minutes long.

The method further involves ensuring that the author provides associated information 230 that the administrator of the hosting site has predetermined as mandatory for the acceptance of the submitted video. This may involve requiring the author to provide information or files associated with the video content 230. For example, the author may be required to provide a title for the video, the name and email addresses of any co-authors, and where co-authors are identified, display order of the authors (such as, 1 for a primary author and 2, 3, 4 etc. for each of the identified co-authors). A web crawler program may also be able to find information, particularly descriptive statistics of relevance about the author, such as, current number of published peer-reviewed publications. The predetermined information further includes a brief overview of the video content and one or more keywords or metatags associated with the video content.

The author may additionally be required to provide information on the following: the procedure depicted in the video, instrumentation (for example, the type and manufacturer), indications and contraindications, setup, preoperative workup, anatomy and landmarks, advantages and disadvantages of the surgical procedure, complications and risks, acknowledgements, references, and like information. The author may also be required to provide information required to categorize the video content. For example, the author may be required to identify whether the video content related to general surgery, pediatric surgery, neurosurgery, otolaryngology, ophthalmology, obstetrics and gynecology or another medical or surgical discipline. The author may also be required to identify intended audience for the video content. For example, the intended audience may be patients and their families, caregivers, medical students or residents, trainees, medical practitioners and surgeons, nurses and paramedical staff, pharmaceutical companies, hospitals, medical device companies, and, in general, any person who may be interested in viewing the hosted videos. The author may further be required to agree to assign their copyright in the video to the administrator of the video hosting site. As used herein, the administrator of the video hosting site may include without limitations, an individual or entity that owns and/or administers the video hosting site, an agent, licensee, assignee or other designee of the individual or entity that owns and/or administers the rights to the video hosting site. While an Informed Consent may not be required to be submitted for acceptance of the video, the author may be required to obtain it for his files. Additionally, the author may be required to verify that they have complied with any other institutional, regulatory or governmental rules, regulations or policies in the creation and submission of the video content.

The video hosting site may include program code that automatically verifies if the submitted information complies with predetermined system rules. For examples, some of the above-described information may be designated as mandatory information. If the author does not provide the relevant mandatory information, the video may be refused 260 for publication review. The author can then resubmit the video and provide the missing information. If the relevant mandatory information is provided, program code may automatically determine if co-authors have been identified by the author. If the author indicates the existence of co-authors, the program code automatically determines if the co-authors have provided any required mandatory information. For example, the program code can determined if the co-authors have also agreed to assign their copyright in the video content to the administrator of the video hosting site. If the program code determines that the mandatory information has not been submitted, an automated notification is sent to the email addresses of the co-authors to obtain the missing information 240. The information obtained from the co-authors may also be validated to verify if it complies with the predetermined rules. When all mandatory information is obtained from the authors and co-authors, the video and associated information may be accepted for publication review 250.

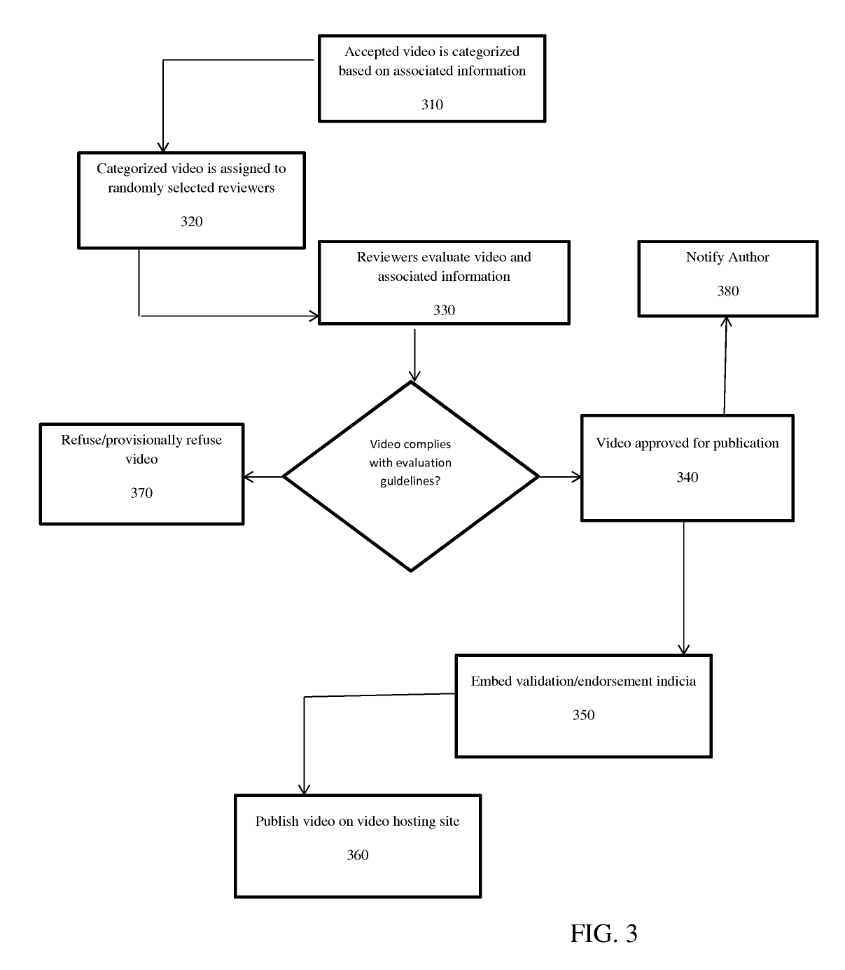

FIG. 3 illustrates a flowchart for a method for publishing an accepted video. The method involves automatically categorizing the video based on the associated information provided by the author 310. For example, the video may be automatically categorized as a general surgery video based on the keywords or title information provided by the author. The categories or subject matter terms may be predetermined by the administrator to include common medical and surgical procedures and specialties. For convenience, each of the subject matter terms may also be associated with a unique digital image or icon or an emoji that is indicative of the medical or surgical procedure.

Each of the predetermined subject matter terms may be associated with a plurality of reviewers in that subject matter area. The reviewers may be identified and selected based on their expertise in a particular subject matter area or specialty. A computer program may be employed to automatically identify a subject matter expert to review the video by comparing the subject matter of the video content with the subject matter discipline of the reviewers. The reviewers serve as peer reviewers of the accepted videos. For example, the subject matter term “neurosurgery” may be associated with a list of neurosurgeons who have previously agreed to review and evaluate accepted videos depicting neurosurgical procedures. The reviewers may include surgeons and other medical practitioners and academics. The reviewers may evaluate the accepted video for accuracy, validity and quality before approving the videos for publication. The names of the reviewers, their contact information (such as, their mailing address, email addresses, etc.), university affiliation, specialty, geographical location, and such relevant information may be stored in a reviewer database.

The method involves analyzing the subject matter terms and responsive to the analysis, automatically assigning the accepted video to at least two randomly selected reviewers who have been identified and selected as reviewers in that subject matter 320. The automatic random selection substantially ensures the removal of any bias in the evaluation and review process. The random selection can be based on a computer algorithm. The randomly selected reviewers constitute a de facto review panel. In one aspect, the video may be randomly assigned to a review panel having three designated subject matter experts. The assignment and evaluation history for each video may be tracked and the results stored in a database.

The method further involves requiring each of the assigned reviewers to evaluate the video content and associated information based on previously determined evaluation guidelines or criteria 330. The evaluation criteria may be compiled into a standardized questionnaire that may be available for input on the video hosting site. This video questionnaire may include, for example, questions on the appropriateness of the video content, the innovativeness of the video content and whether the reviewer would recommend the video content for publication.

The assigned reviewer may be required to respond to each of the questions in the video questionnaire on a rating scale. For example, a 5-point rating scale can be used to rank the answers. A predetermined weight may be assigned to each answer choice. For example, a “strongly disagree” answer choice may be assigned a weight 1, a “disagree” answer choice may be assigned a weight 2, a “neutral” answer choice may be assigned a weight 3, an “agree” answer choice may be assigned a weight 4 and a “strongly agree” answer choice may be assigned a weight 5. However, it is understood, that this scale is merely exemplary and a reverse ranking (that is, a weight of 1 being assigned to a “strongly agree” answer) may also be used. The sum or total weighted score, as determined by a first assigned reviewer, for an accepted video can be tabulated against the total weighted score assigned to the accepted video by a second (and subsequent) assigned reviewer.

The accepted video and associated information may be considered to be compliant with evaluation guidelines if the total weighted score as determined by each of the assigned reviewers may be greater than or equal to a previously determined minimum threshold score. If the video content and associated information are found to be compliant with the evaluation guidelines, the video may be approved for publication 340. After the video is accepted for publication, an automated electronic mail (email) may be sent to the author notifying him about the publication decision 380.

In one embodiment, as a further quality control mechanism, the approved video may be subjected to a secondary evaluation process. An editorial panel may be convened by the administrator. The editorial panel may include two or more subject matter experts. The editorial panel further reviews each approved video to ensure compliance with the plurality of evaluation criteria. In another embodiment, a computer algorithm can randomly select videos for additional review by the editorial panel. In yet another embodiment, the editorial panel may randomly select approved videos for undergoing the secondary evaluation process. The editorial panel can be provided with administrator access to the portal. The editorial panel may have access to all submitted and rejected videos. The editorial panel may be authorized to add and remove videos, authors and reviewers on the portal.

The accepted video and associated information may be considered to be non-compliant with evaluation guidelines if the total weighted score as determined by each of the assigned reviewers may be less than a previously determined minimum threshold score. If the video content and associated information are found to be non-compliant with the evaluation guidelines, the video may be refused 370. Alternately, the video may be provisionally refused 370. If the video is provisionally refused, the author may be advised of required changes to the video content and/or information in order for the video to be found compliant. A refused or provisionally refused video may be resubmitted for further consideration.

For instance, one or more reviewers may require that certain revisions or editorial changes may be necessary before the video can be approved for publication. In such an instance, the video may be returned to the author with a request to make the required revisions. The author may be notified of the refusal decision, or the provisional refusal decision, by an automated email. The author can be invited to resubmit the revised video upon making the required changes.

In one aspect, the revised video may be reassigned automatically to the reviewers that initially reviewed it. The revised video is again evaluated based on the standardized video questionnaire, and if the total weighted score as determined by each of the assigned reviewers may be greater than or equal to a previously determined minimum threshold score, the revised video may be approved for publication. If the the total weighted score as determined by each of the assigned reviewers may be less than a previously determined minimum threshold score, the revised video may be issued a final rejection.

Alternately, in another embodiment, the revised video may be submitted directly to the editorial panel for further review. The editorial panel may analyze the revised video to ensure that the changes proposed during the initial review were made by the author. If the editorial panel determines that the required changes have been made, it can approve the revised video for publication on the online portal. If the editorial panel determines that the required changes have not been made, it can issue a final rejection and refuse to publish the video.

If it is determined that minor revisions are required, for example, minor changes are required to the abstract, title or keywords associated with the video, the editorial panel can collaborate with the author to make the necessary changes. The editorial panel can then approve the video for publication after the required changes are made.

The method further involves using computer code to automatically assign the approved videos a first status indicator. The first status indicator is representative of acceptance of the video for publication. On the other hand, a refused video may be automatically assigned a second status indicator. The second status indicator is representative of refusal of the video for publication.

Pre-determined indicia may be automatically embedded in the video having the approved for publication status 350. The indicia may be representative of validation or endorsement of the video content. The indicia may include any predetermined data item or an information element. The information element may include a logo, a word, phrase, number(s) or combinations thereof. In one aspect, the indicia may include a digital watermark. Advantageously, the digital watermark can facilitate tracking the online use of the digital videos and can warn the administrator of the video hosting site against potentially unauthorized access and/or use. The watermark may include an identification of the video owner, a second level domain portion of an URL associated with the surgical video hosting site, the URL associated with the surgical video hosting site and combinations thereof. Alternately, the watermark may be manually embedded by a media player operated by an administrator of the video hosting site. The approved for publication video can be published on the video hosting site as an endorsed video 360. In one or more embodiments, a suitable device such as, an online video converter may be used to upload and convert the videos into a predetermined format. Online video converters are known in the art. The format may be one of .mp3, .mp4, .flv, .aac, .ogg, .wma, .m4a, .flac, .wav, .avi, .mpg, .mov, .wmv, .mkv, .m4v, .webm, .3gp. or another format. The published video may be accessed at the video hosting site using a suitable media player.

At least one search term may be associated with the published video. The search term may correspond with the subject matter categories discussed earlier. The author(s) of the video may receive a publication credit for the published video. After the video is published on the video hosting site, it can be accessible to any user who is interested in the surgery or the subject matter of the video.

The novel review and publication approval process disclosed herein ensures that the content of the videos published is of consistently high quality. The published videos are endorsed videos since they can provide an accurate representation of surgeries performed in any surgical field. Since the reviewers assigned to evaluate the video may be peers of the author of the video, the embodiments disclosed herein involve facilitating a guideline-based peer-review of the video before it can be published in an online medium. Consequently, the published videos may be considered to be more reliable than videos that are published in various online sites and forums, including those published on hospital websites or other medical websites. The peer-reviewed videos may also serve as a valuable public service.

Furthermore, the publication of such a peer-reviewed video may provide the author with tangible and intangible benefits. For instance, the peer-reviewed publication of the video may be important to academics in their promotion process. Publication of the video may also enhance the name recognition of the author. The author may come to be acknowledged as an expert in a surgical procedure by the general public.

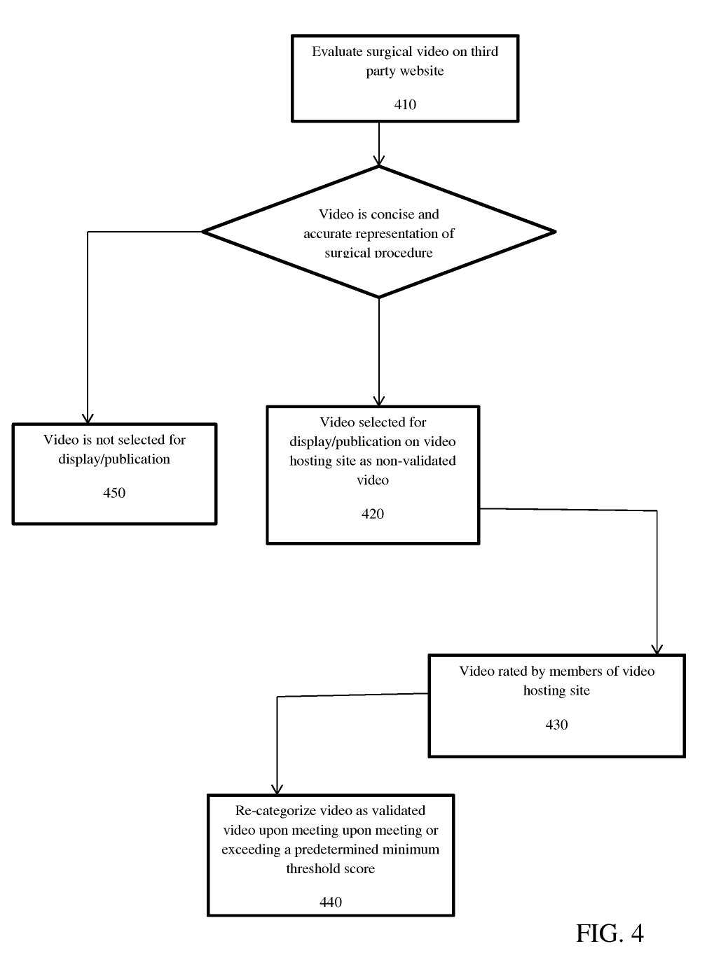

FIG. 4 illustrates a flowchart for method for accepting videos for display according to another embodiment. The video hosting site may also be used to access non peer-reviewed videos that are found on third party websites on the Internet. In one aspect, the content on the third party or “external” sites may be identified through an algorithm or through a web crawler program which analyzes the video content to identify subject matter related to a desired surgical procedure.

The content of the external videos may be initially evaluated by at least one of the following: an administrator of the video hosting site, at least one member of an editorial panel or a reviewer in a subject matter discipline 410. The initial evaluation may be based on guidelines drafted by the administrator of the video hosting site or by the editorial panel. For example, the guidelines may require that the external video content satisfy one or more of several criteria, such as, high quality, conciseness, accuracy in representing a surgical procedure, innovativeness and appeal to a broad range of users.

If the initial evaluation determines that the external video content meets these guidelines, the video may be selected or identified as a “non-validated video” 420. Since a non-validated video does not undergo a peer-review process, it is not endorsed by the video hosting site. The non-validated videos may be appropriately identified to distinguish them from the peer-reviewed videos. For example, a peer-reviewed video may be embedded with a validation indicia, such as, a symbol and/or textual information associated with the title of the video to denote endorsement of the video. A non-peer reviewed, non-endorsed video may not include any embedded identifiers. However, if the external video content does not meet the guidelines, the video may not be selected for display 450.

If approved by the appropriate copyright owners, the content of the non-validated may be accessed or displayed directly on the video hosting site. Alternately, a user may be provided a link (such as, a hyperlink), pointer or any other mechanism known in the art, to directly access the identified non-validated videos from the video hosting site.

Registered members or subscribers of the video hosting site are given an opportunity to rate the contents of the non-validated videos. After a non-validated video is viewed (either on the video hosting site or at a third party site), a member can rate the contents of the non-validated video on the video hosting site 430. For example, a pop-box may be automatically displayed on the video hosting site as soon as the third-party video is accessed. The pop-box may include a simple survey which where the member is allowed to rate the video. The video hosting site ensures that each member can rate the contents of a non-validated video only once. The contents of the non-validated video may be rated based on a set of criteria determined by the administrator of the video hosting site. The criteria may be identical to or a sub-set of the previously described guidelines used to evaluate the content of the videos accepted for publication. The mean score from all reviews can be summed and displayed as a video score. (In other embodiments, instead of a mean score, an average, median, weighted, normalized score may be automatically computed). This score is continuously tabulated and displayed. According to an embodiment, the score may be automatically calculated in substantially real time. After a non-validated video receives a predetermined number of reviews with a mean score value that meets or exceeds a predetermined score value, the non-validated video can be re-categorized as a validated or endorsed video 440. According to an aspect, the endorsed video may be grouped with the peer-reviewed videos.

By aggregating the non-peer reviewed videos, or hyperlinks thereto, and displaying them at the video hosting site, users of the video hosting site can conveniently have a single point of access to see the surgical videos recommended by members of the video hosting site. Furthermore, this affords the owners of the video hosting site an additional format for attracting users and generating revenues.

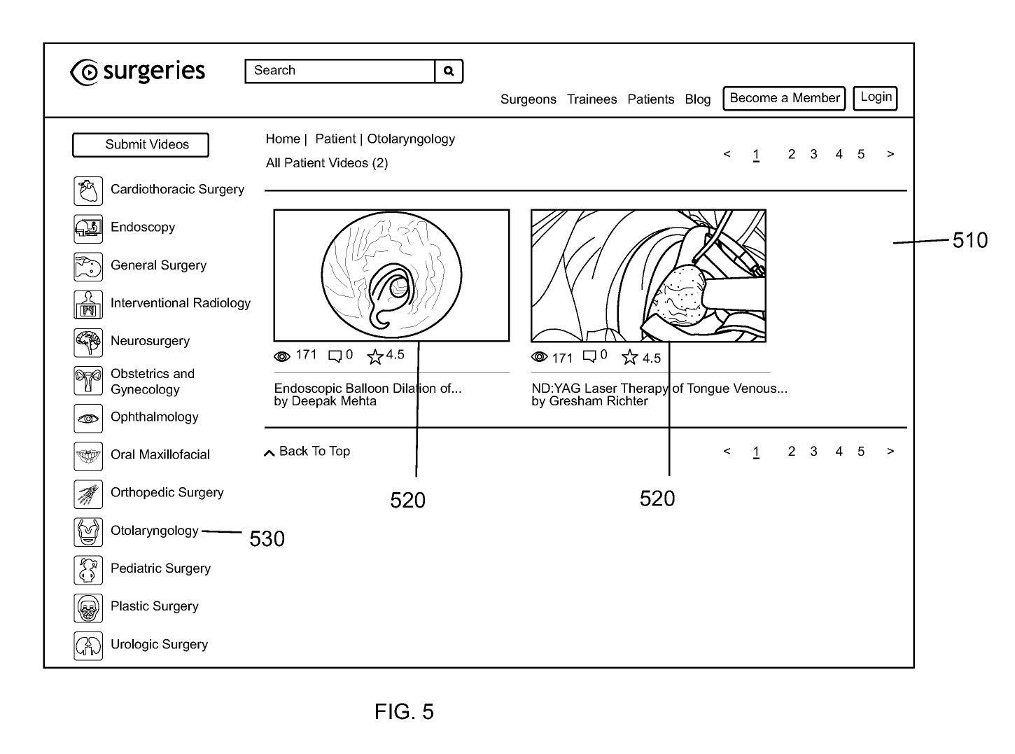

FIG. 5 is a screenshot of an exemplary webpage hosted by the video hosting site 510. The video hosting site can serve as a resource for teaching basic and complex surgical techniques. The video hosting site provides otherwise unavailable videos and information on surgical and medical procedures which can be trusted for accuracy since they have undergone a peer review process by international expert reviewers in the respective surgical field. The video hosting site may include an embedded media player known in the art. The published video may be displayed via the embedded player at the video hosting site.

The video hosting site may be a dedicated online repository for hosting a library of validated or peer-reviewed videos 520. Non-validated videos may also be displayed on the video hosting site. The content of the videos can be published on the video hosting site where it can be accessed by The external user may be patients and their families, caregivers, medical students or residents, trainees, medical practitioners and surgeons, nurses and paramedical staff, pharmaceutical companies, hospitals, medical device companies, and, in general, any person who may be interested in viewing the hosted videos. Although all users may view the videos hosted on the video hosting site, only registered members of the video hosting site may be permitted to submit videos. Also, only members may be permitted to rate non-validated videos.

The published videos may be classified or categorized based on the subject/content and the respective surgical field(s) for ease of access and retrieval 530. For convenience, a unique digital image or icon or an emoji that is indicative of the medical or surgical procedure appears next to the category listing. Each published video may be associated one or more retrieval keywords to facilitate convenient access to the published videos.

The video hosting site can serve as a useful resource for teaching basic and complex surgical techniques, and a venue where surgical innovations can be shared within members of the same surgical specialty. The video hosting site may further provide a forum for a user to interact with the authors, reviewers and editors. The forum may be configured to allow a user or author to discuss surgical complications and their management.

The published videos may be archived with a digital archiving service to ensure ongoing availability to the videos. The published videos can be indexed in common academic databases, such as, PubMed and Google Scholar.

The embodiments of the invention may be implemented as a computer-implemented method, on a data processing apparatus and as a computer program product using computer program instructions. These computer program instructions may also be stored in a computer readable medium that can direct a computer, other programmable data processing apparatus, or other devices to function in a particular manner, such that the instructions stored in the computer readable medium produce an article of manufacture including instructions that implement the function/act specified herein.

The computer program instructions may also be loaded onto a computer, other programmable data processing apparatus, or other devices to cause a series of operational steps to be performed on the computer, other programmable apparatus, or other devices to produce a computer implemented process such that the instructions which execute on the computer or other programmable apparatus provide processes for implementing the functions/acts specified herein.

As used herein, the words “comprise,” “have,” “include,” and all grammatical variations thereof are each intended to have an open, non-limiting meaning that does not exclude additional elements or steps. Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. It is, therefore, evident that the particular illustrative embodiments disclosed above may be altered or modified and all such variations are considered within the scope and spirit of the present invention. For example, the review and publication approval process discussed herein may be used in other industries or fields where validation of a specialized technique is required. For instance, the embodiments of the invention may be used to ensure the validity of online academic tutorial videos. It can also be used to ensure the validity of magician training videos, construction videos, craft-related videos, etc. Also, although the embodiments of the invention have been described with reference to a video hosting site, it is understood that the methods and systems described herein for validating a digital video can be embodied on any device, software program (e.g., an application or “App”) and/or other interface.

While the embodiments are described in terms of “comprising,” “containing,” or “including” various components or steps, the battery and methods also can “consist essentially of” or “consist of” the various components and steps. In particular, every range of values (of the form, “from about a to about b,” or, equivalently, “from approximately a to b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an”, as used herein, are defined to mean one or more than one of the element that it introduces. If there is any conflict in the usages of a word or term in this specification and one or more patent(s) or other documents that may be incorporated herein by reference, the definitions that are consistent with this specification should be adopted.

What is claimed is:

1. An Internet-based method for validating a digital video comprising:
submitting the digital video to a dedicated surgical video hosting website, wherein the video comprises content on a surgical procedure, and wherein submitting the video comprises:
using a drag and drop movement, copying the video from a client device to a designated region on a webpage of the video hosting website;
using a computer system, analyzing and accepting the video for a pre-publication review, wherein the video is accepted for the pre-publication review upon ensuring that the video content is in compliance with a set of predetermined criteria, and wherein the pre-publication review comprises:
using a computer algorithm, automatically assigning the accepted video to at least two randomly selected reviewers;
upon receipt of approval from each of the randomly selected reviewers, using the computer system, automatically associating an approved for publication status identifier with the video; and
embedding pre-determined digital data in the video having the approved for publication status identifier, wherein the digital data comprises an indicia representative of validation of the video content.

2. The method according to claim 1, further comprising submitting predetermined information associated with the video, wherein the predetermined information comprises one or more metatags or keywords, an overview of the surgical procedure and an abstract of the surgical procedure.

3. The method according to claim 2, wherein the computer system analyzes the one or more metatags or keywords prior to assigning the video to each of the reviewers.

4. The method according to claim 1, wherein each of the selected reviewers is experienced in the surgical procedure.

5. The method according to claim 1, further comprising automatically storing, in a non-transitory computer readable storage medium, information pertaining to a plurality of designated reviewers, wherein each of the designated reviewers is experienced in at least one surgical procedure.

6. The method according to claim 1, wherein the validation indicia comprises a data item or an information element, wherein the information element comprises a logo, a predetermined word, phrase, number or combinations thereof.

7. The method according to claim 1, wherein the validation indicia comprises a digital watermark, wherein the digital watermark comprises a second level domain portion of an URL associated with the surgical video hosting website, the URL associated with the video hosting website and combinations thereof.

8. The method according to claim 7, further comprising publishing the digitally watermarked video on the video hosting website.

9. The method according to claim 8, further comprising converting the video into a predetermined format prior to publishing.

10. The method according to claim 8, further comprising automatically categorizing the published video based on the surgical procedure.

11. The method according to claim 10, further comprising associating a digital image with the categorized published video.

12. An Internet-based method for validating a digital video comprising:
using a computer system, evaluating and analyzing content of a surgical video embedded in a third party website;
accessing the video on the third party website from a dedicated surgical video hosting website, wherein the video is accessed upon the condition that the content of the evaluated video satisfies predetermined guidelines;
using the computer system, associating a non-validated status identifier with the accessed video, wherein the associated status identifier is displayed on a webpage of the video hosting site;
automatically permitting registered members of the video hosting website to assign a score to the accessed video based on a plurality of evaluation criteria; and
using the computer system, automatically modifying the status identifier to a validated status upon detecting that the video has been assigned a score that meets or exceed a predetermined threshold score.

13. A computer system comprising:
a dedicated surgical video hosting site;
one or more computer processors; and
a non-transitory computer-readable storage medium having computer-executable instructions that configure the one or more processors for:
submitting the digital video to a video hosting website, wherein the video comprises content on a surgical procedure, and wherein submitting the video comprises:
using a drag and drop movement, copying the video from a client device to a region on a webpage of the video hosting web site;
analyzing and accepting the video for a pre-publication review, wherein the video is accepted for the pre-publication review upon ensuring that the video content is in compliance with a set of predetermined criteria, and wherein the pre-publication review comprises:
using a computer algorithm, automatically assigning the accepted video to at least two randomly selected reviewers;
automatically associating an approved for publication status identifier with the video; and
embedding pre-determined digital data in the video having the approved for publication status identifier, wherein the digital data comprises an indicia representative of validation of the video content.

14. The computer system according to claim 13, wherein the non-transitory computer readable storage medium further comprises information pertaining to a plurality of designated reviewers, wherein each of the designated reviewers is experienced in at least one surgical procedure.

15. The computer system according to claim 13, further comprising submitting predetermined information associated with the surgical procedure, wherein the predetermined information comprises one or more metatags or keywords, an overview of the surgical procedure and an abstract of the surgical procedure.

16. The computer system according to claim 13, wherein the processor is configured for analyzing the one or more metatags or keywords prior to assigning the video to each of the reviewers.

17. The computer system according to claim 13, wherein each of the selected reviewers is experienced in the surgical procedure.

18. The computer system according to claim 13, wherein the validation indicia comprises a data item or an information element, wherein the information element comprises a logo, a predetermined word, phrase, number or combinations thereof.

19. The computer system according to claim 13, wherein the validation indicia comprises a digital watermark, wherein the digital watermark comprises a second level domain portion of an URL associated with the video hosting website, the URL associated with the surgical video hosting website and combinations thereof.

20. The computer system according to claim 19, further comprising the computer-executable instructions for publishing the watermarked video on the video hosting website.
